(19) United States
(12) Patent Application Publication
(10) Pub. No.: US 2017/0118968 A1
(43) Pub. Date: May 4, 2017

(54) Wearable and Portable Fishing Bait Container with Aerator

(71) Applicants: Joe Gimesky, San Antonio, TX (US); Becki Rinner-Doege, San Antonio, TX (US)

(72) Inventors: Joe Gimesky, San Antonio, TX (US); Becki Rinner-Doege, San Antonio, TX (US)

(21) Appl. No.: 14/931,255

(22) Filed: Nov. 3, 2015

(51) Int. Cl. A01K 97/05

(52) U.S. Cl. CPC A01K 97/05

(57) ABSTRACT

A container for storing and preserving fishing bait. The container is specially designed for live bait, especially water-based bait. The container and certain embodiments can be worn along the waist of a fisherman. In the number of embodiments the container stores an aerator to supply oxygen to the water and preserve the water-based bait contained within. The container frequently includes a cover unit allowing a fisherman to insert his or her hand into the container to withdraw a bait while keeping the remaining bait inside of the container.

### CROSS REFERENCES TO RELATED APPLICATIONS

Not applicable.

### FEDERALLY SPONSORED RESEARCH OR DEVELOPMENT

Not applicable.

### BACKGROUND OF THE INVENTION

1. Field of the Invention

The present invention relates generally to fishing bait containers, and in particular, fishing bait containers that are wearable and comprise an aerator.

2. Description of the Related Art

Fishing is a popular hobby. Like most hobbies, enthusiasts of fishing look for ways to make the experience more enjoyable while participating. Enthusiasts have found ways to track and lure fish better, pass time while fishing, and improve existing hardware. One area for improvement most fundamental to catching fish is properly storing live bait prior to deployment. A wide variety of live bait are available including worms, crickets, frogs, shrimp, other fish, and many more. Given the wide variety of types of bait, the techniques for properly preserving and keeping such bait are nearly if not more broad. One issue common amongst nearly all types of bait is ensuring that the container allow the fisherman to freely insert his or her hand to grab a bait, and prevent other bait from escaping.

Issues surrounding the storage and preservation of live bait often involve minimizing stress to the live bait and keeping the storage media as close to the bait's native conditions is possible. Consequently, the conditions necessary to store and preserve water-based live bait, such as fish and shrimp, are necessarily different than those of dirt based bait, such as crickets and worms. For the water-based variety of live bait, storage containers typically contain water. As a result, the container is often awkward and heavy, presenting more issues for the enthusiasts. Whether on a boat, the shore, or in the water, fishing enthusiasts often prefer to remain stationary so as to not startle the fish. Given the awkwardness and heaviness of current containers, enthusiasts frequently move back and forth between their fishing spot in the position where they have placed the bait container. Another issue arises when dealing with water-based bait: insufficient supply of oxygen to the water increases the likelihood of fatality amongst water-based bait.

Enthusiasts have previously attempted to address some of these issues, but have fallen short. For instance, Ward (U.S. Pat. No. 7,017,297) teaches a container for live fish having a handle and a point of entry for the fishermen to insert his or her hand into the container. To some extent, Ward still requires the fishermen to move in order to retrieve live bait. And although

Ward provides for air holes near the upper portion of the container, oxygen diffusion across the water surface of the vertical container is minimal.

The present invention eliminates these problems. The present invention—their various embodiments—is intended to be worn by the fisherman. Elements making embodiments of the invention wearable include: curvature along one side for placement along fisherman's waste; belt loops and/or strap(s) with a hook and loop material for attachment; and lightweight materials. In most embodiments, the container includes a rubber or similar material based diaphragm connected to the water-based portion of the container. As a result of these components, or combinations, modifications and variations thereof, the present invention is an effective wearable and portable fishing bait container.

### BRIEF SUMMARY OF THE INVENTION

In the embodiment discussed herein, the present invention contains a fishing bait container consisting of a container, a lid, a compartment for holding an aerator, an aerator, a hose, an airstone, a cover unit, and a belt and/or belt loop(s). The container can hold water and/or live bait and the compartment for holding the aerator. Along the outside of the container may be a belt loop(s) for securing a belt. Alternatively, the container may be secured to the user's body with hook and loop material secured to the container and a belt. The aerator connects to the hose, and delivers oxygen to an airstone, which is secured inside of the container. The container is closed using a cover unit comprising a diaphragm. The container may be used for storing live bait for fishing and other applications. These elements, along with other elements, may be included in various embodiments of the invention.

In view of the foregoing, the principal object of the present invention is to provide a fishing bait container that extends the life of live bait.

It is another object of the present invention to provide a fishing bait container that is comfortable and easy to wear.

It is another object of the present invention to prevent fishing bait from escaping from the fishing bait container.

It is another object of the present invention to make it easy for the fisherman to access fishing bait from the fishing bait container.

These and other objects and advantages of the present invention will become apparent to one skilled in the art from the detailed description of the invention and the claims, with it understood that other configurations or substitutions of material may be used and are included within the scope of the claims of this invention.

### BRIEF DESCRIPTION OF THE SEVERAL VIEWS OF THE DRAWINGS

FIG. 1 is a top side frontal perspective view of the present invention.

FIG. 2 is a top side rear perspective view of the embodiment shown in FIG. 1.

FIG. 3 is a cross-sectional plan view of the embodiment shown in FIG. 1.

FIG. 4 shows the embodiment from line 4-4 of FIG. 3.

FIG. 5 is a plan partial view of an alternative embodiment.

FIG. 6 shows the embodiment from line 6-6 of FIG. 5.

FIG. 7 shows a sectional left view of the embodiment shown in FIG. 1.

FIG. 8 is an environmental view of the present invention coupled to a user's waist.

### DETAILED DESCRIPTION OF THE INVENTION

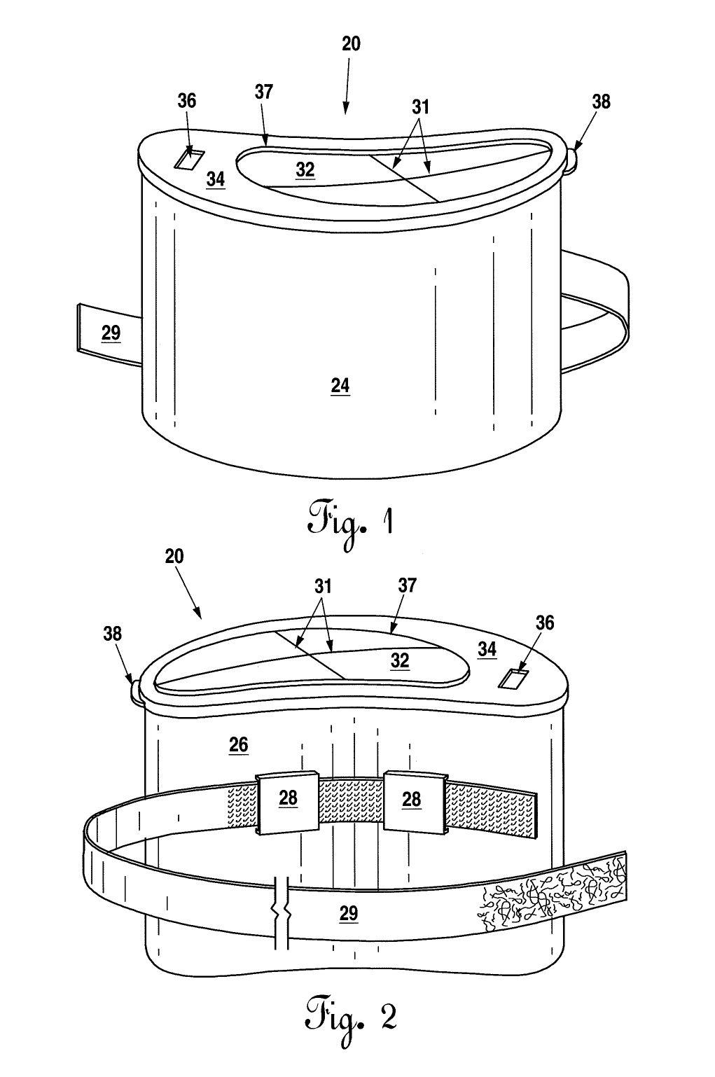

FIGS. 1 and 2 depict the preferred embodiment of the present invention. The invention is characterized as a container 20 having a bean-shaped cross section with a concave front surface 24 and convex rear surface 26. In certain embodiments, the rear surface 26 is intended to generally comport with the curvature of a fisherman's waist. The container has an upper, open end which can be covered with a cover member or lid 34, having a rubber diaphragm 32 for easy access to the interior of the container 20.

In one embodiment of the invention, the container 20 is attached to the fisherman by a belt 29 which fits through loop(s) 28 positioned on the rear surface 26 of container 20 for placement of the container 20 along a fisherman's waist. The ends of the belt 29 may be secured with a clasp or with hook and loop material as shown in FIG. 2. In another embodiment, the belt 29 may have hook and loop material which connects to patches of hook and loop material (not shown) attached to the rear surface 26 of the container 20.

The container 20 material could be made malleable or rigid. Malleability of the container 20 may provide advantages in added comfort and reducing the container's footprint for storage purposes—especially if it is compressible in one or more axis.

Regardless of shape, the container 20 in some embodiments could hold dirt for storing worms and crickets, etc. or water for water-based bait. Neither of these options should be construed as limiting. Additionally, certain embodiments will include access for the fisherman to insert his or her hand into the container 20 and grab bait. In the embodiment illustrated in FIG. 1, the access is the rubber diaphragm 32 attached to and covering a first opening 37 in the removable cover member 34. In addition to allowing the fisherman access, the rubber diaphragm 32 prevents bait from escaping the container 20. The cover member 34 may be made of plastic or rubber but other materials may also be used. Alternatively, the cover member 34 may be removable, fixed or partially connected to the container 20. FIG. 1 and FIG. 2 also illustrate a small second opening 36 positioned through the cover member 34, which is discussed in greater detail below. Alternative embodiments might not include the second opening 36. The cover member 34 might also include a tab 38 useful for prying the cover member 34 from the top of the container 20.

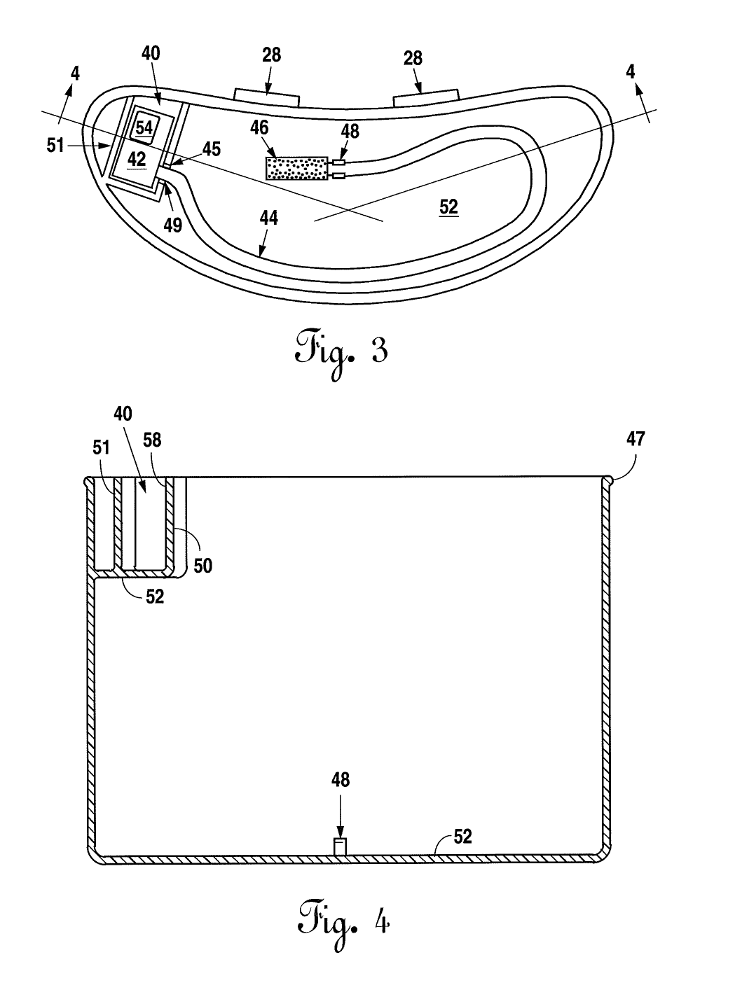

Referring to FIGS. 3, 4 and 7, the container 20 includes a first compartment 40 used for holding an aerator 42 having a switch 54. The types of aerators that might be used might dictate the shape and position of the compartment, and vice versa. In particular, the type of aerator will likely dictate to what extent the first compartment 40 might be sealed from the remainder of the container 20. Additionally, the means by which an aerator operates or supplies oxygen to the container 20 should not be construed as limiting. In this embodiment, the aerator 42 includes a pump (not shown), a switch 54 and connects to a hose 44. The hose 44 exits the first compartment 40 into the interior of the container 20 and supplies oxygen to an airstone 46 inside the container 20. As oxygen is released from the airstone 46 into the water of the container 20, the fisherman extends the longevity of the live bait contained therein. In certain embodiments the hose 44 may be secured by a clamp 48 attached to a bottom internal surface 52 of the container 20. Although FIG. 3 and FIG. 4 depict a clamp 48 centrally located on the bottom internal surface 52 of the container 20, a clamp 48 may be positioned closer to the interior walls of the bait container 20. Additionally, positioning the clamp 48 and the airstone 46 along the bottom internal surface 52 may optimize the release of oxygen from the airstone 46. In particular, the path of oxygen flow is increased as the oxygen flows from the airstone 46 positioned at the bottom internal surface 52 to the surface of the water contained (not shown) in the container 20.

The hose 44 may exit the first compartment 40 by a number of paths. In the preferred embodiment, the hose 44 passes through an opening 45 in the first vertical portion. In this embodiment, a seal 47 may be positioned around the edge of the opening which creates an interference fit with the hose 44 and a sealed barrier at the opening. Alternatively, the hose 44 may exit through the top of the first compartment 40 and reenter the container 20, either through the rubber diaphragm 32, or a hose reentry point (not shown) in the cover member 34.

In the preferred embodiment disclosed in FIG. 4, the first compartment 40 comprises a first vertical partition 50, a second vertical partition 51, and a lower horizontal partition 52 to separate the first compartment 40 from the interior of the container 20. Alternatively, the compartment may have fewer or additional vertical partitions if it is desired for the partitions of the compartment to conform to the shape of the aerator. The top edge of the first vertical partition 50 and the second vertical partition 51 are co-planer with the top edge of the lip 43 of the container 20.

In the preferred embodiment, a seal or gasket 58 is positioned against the underside surface 39 of the cover member 34 so that it compresses between the cover member 34 and the top edges of the lip 43 and the first and second vertical partitions 50, 51 when the cover member 34 is in place. In this manner, a sealed barrier is created around the lip 43 and between the compartment 40 and the interior of the container 20.

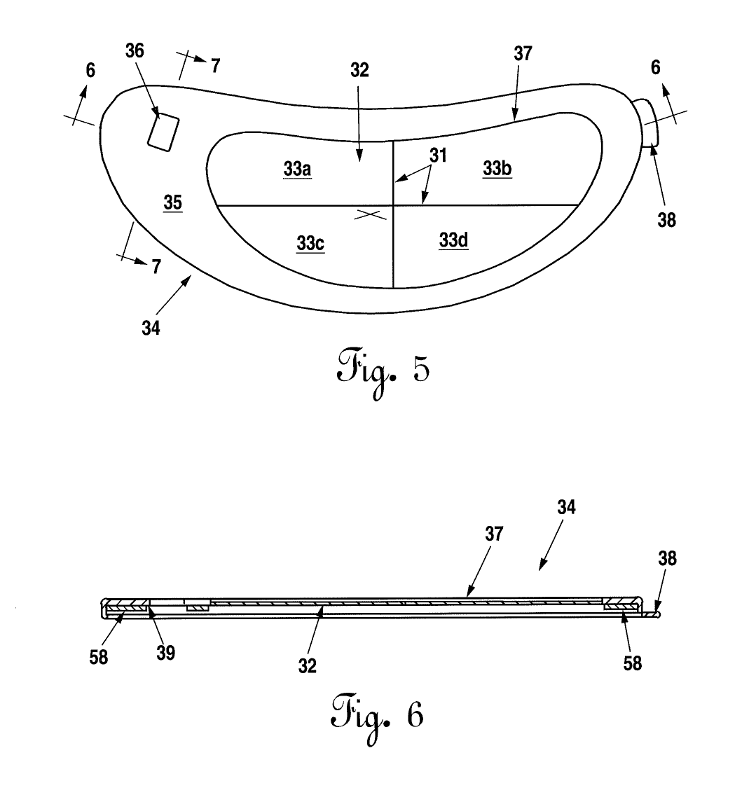

FIG. 5 and FIG. 6 illustrate the cover member 34 in more detail. The cover member 34 has a flat planar upper surface 35, and a flat planar underside surface 39. A first opening 37 extends through the cover member 34, and is sized to allow a user's hand to fit therethrough. The first opening 37, is covered with a diaphragm 32 which has slits 31 therethrough. In the preferred embodiment, there are two perpendicular slits 31 which cut the diaphragm into four separate diaphragm members 33a, 33b, 33c and 33d. Each of the diaphragm members, 33a, 33b, 33c and 33d, are attached to the cover member 34 adjacent their outer edges but are separated from each of the other diaphragm members at their interior edges. In this manner, the interior edges of the flexible diaphragm members 33a, 33b, 33c and 33d will further separate as user's hand is pushed through the diaphragm.

A second opening 36 may also extend through the cover member 34. This second opening 36 is positioned to correspond with a switch 54 on the aerator 42 when placed in the compartment 40 and positioned below the cover member 34. In this manner, a user may activate the aerator switch 54 while the cover member 34 is in place. Preferably the gasket 58 does not cover the second opening 36. However, in some embodiments, the second opening 36 may be covered by the gasket 58. In these embodiments, the gasket 58 may be thin or flexible enough such that the switch 54 may be toggled through the gasket 58.

The cover member 34 has a continuous rim 43 with a lip 41 at its distal end. The lip 41 is positioned to interlock with a lip 47 extending outwardly from the top edge of the container 20 (See FIG. 4).

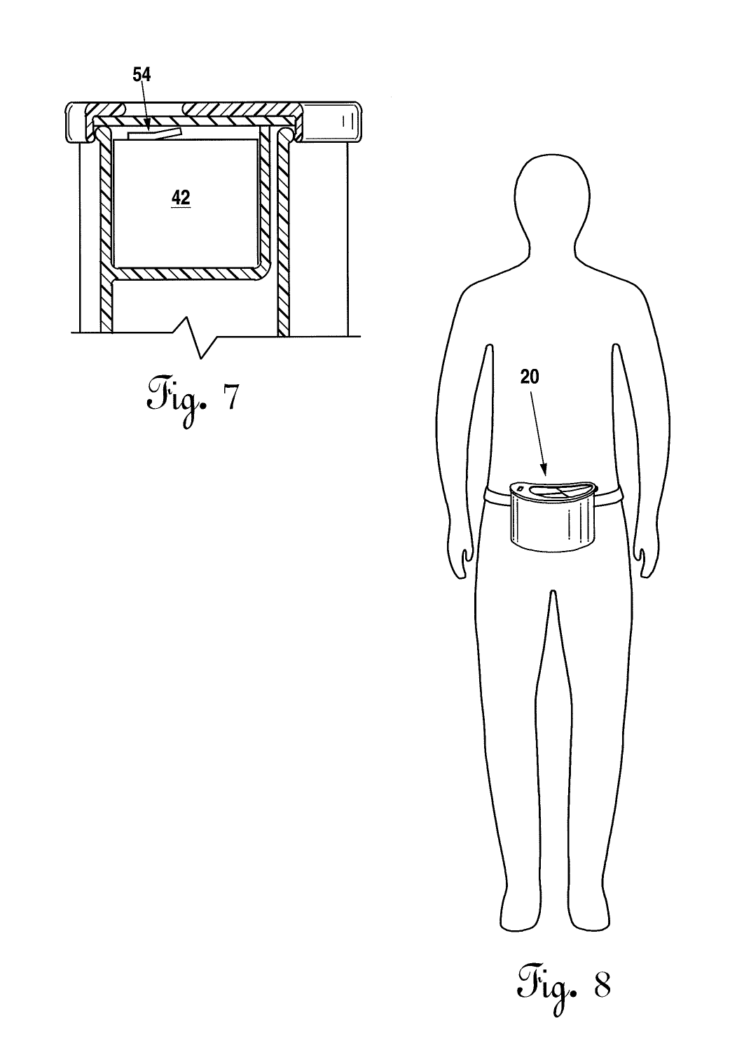

FIG. 7 illustrates an aerator 42 held in a first compartment 40. The aerator 42 is activated by a switch 54.

While the embodiments depicted in the illustrations suggest that the aerator 42 is placed near the upper portions of the invention, it may be placed in different portions of the invention. Alternatively, certain embodiments might not include a compartment for an aerator. Similarly, an aerator per se may not be used, but other devices or means for supplying oxygen to the invention may be employed—or none at all.

This container 20 can be made from a variety of materials, which may include metal, rubber, and/or plastic. The particular thickness and other dimensions of the materials are not particularly important, so long as the pieces are necessarily durable for storing and preserving live bait.

The shape of the invention is generally not critical. In the preferred embodiment, however, the shape of the invention will fit comfortably along the waist of the fisherman as shown in FIG. 8. To that end, the materials used to construct the container 20 when combined with the weight of its contents, should be of a weight that is comfortable for a fishermen to keep at his or her waistline with a belt containing hook and loop material (or other material).

When in use with water-based bait, the fisherman should add water to the invention through the diaphragm 32 or through the top opening of the container 20 when the cover member 34 is not in place or a separate port (as may be included in other embodiments). Once water is added to the container, the fisherman can add water-based bait. If the cover member 34 has been removed, the fisherman should return 15 its position so that the live bait does not escape. If the fisherman intends to use an aerator 42 in a particular embodiment of the invention, the fisherman should turn on the aerator 42 before the live bait is introduced to the water or not long thereafter. At this point, the fisherman is ready to position the invention in front of his or her waist and secure the belt around his or her body. When the fisherman is ready to retrieve live bait, he/she may do so by passing his or her hand through the diaphragm 32 of the cover member 34 and pulling the live bait out.

The present invention is described above in terms of a preferred illustrative embodiment of a specifically described fishing bait container that is wearable and comprises an aerator, as well as alternative embodiments of the present invention. Those skilled in the art will recognize that alternative constructions and implementations of such bait container including different sizes and/or arrangement of components can be used in carrying out the present invention. Other aspects, features, and advantages of the present invention may be obtained from a study of this disclosure and the drawings, along with the appended claims.

We claim:

1. A vessel for storing and preserving live fishing bait comprising:
a container having an interior volume capable of holding water;
a compartment within the container;
an aerator positioned within said compartment;
a lid capable of being secured to a top of the container; and
a first opening through said lid sized to allow a user's hand to pass through said first opening.

2. The vessel of claim 1 further comprising:
a diaphragm covering said first opening in said lid; and
said diaphragm having one or more slits therethrough.

3. The vessel of claim 2 wherein said diaphragm is made of a flexible, resilient material.

4. The vessel of claim 1 wherein said compartment comprises a vertical partition and a horizontal partition which separates said compartment from the remaining interior volume of the container.

5. The vessel of claim 1 further comprising:
a hose connected to said aerator at a first end of the hose; and
a second end of the hose positioned within said interior volume of said container for releasing air into said interior volume.

6. The vessel of claim 5 further comprising:
a clamp attached to an interior surface of the container for holding said hose.

7. The vessel of claim 6 wherein said hose passes through an opening in said vertical partition of said compartment.

8. The vessel of claim 7 wherein a sealing member is positioned around said opening in said first partition.

9. The vessel of claim 1 further comprising:
a second opening in said lid positioned above an activating switch on said aerator.

10. The vessel of claim 1 further comprising:
a sealing member positioned between an upper lip of said container and said lid.

11. The vessel of claim 1 wherein the container is rounded along at least part of its exterior.

12. A belt affixed exteriorly to the container.

13. A vessel for storing bait comprising:
a container;
a first volume within said container capable of holding water;
a second volume within the container;
an aerator positioned in said second volume for introducing air into said first volume of said container; and
a partition separating said first volume from said second volume.

14. The vessel of claim 13 further comprising:
a lid capable of securing to an upper lip of the container;
a first opening through said lid;
a diaphragm having one or more slits therethrough covering said first opening; and
a hose having a first end connected to said aerator and having a second end extending into said second volume.

15. The vessel of claim 13 wherein said hose passes through an opening in said partition; and
an airstone connected to the hose at a second end of the hose.

16. The vessel of claim 15 further comprising:
a sealing member surrounding said opening in said partition.

17. The vessel of claim 14 further comprising:
a fastener attached to an interior surface of the container for securing said hose.

18. The vessel of claim 14 further comprising:
a sealing member positioned between said lid and said upper lip of said container.

19. The vessel of claim 15 further comprising:
a sealing member positioned between said lid and an upper edge of said partition.

20. The vessel of claim 14 further comprising:
a belt affixed exteriorly to the container.

21. The vessel of claim 14 wherein the container is rounded along at least part of its exterior.

22. A method of storing and accessing bait from a container comprising:
adding water to a first volume of a container;
positioning an aerator in a second volume of said container wherein said second volume is partitioned from said first volume;
aerating said water in said second volume of said container with said aerator;
adding live bait to said first volume of said container; and
placing a lid on the container wherein said lid has an opening covered by a diaphragm.

23. The method of claim 22 further comprising:
fluidly sealing said first volume from said second volume.

24. The method of claim 22 further comprising:
fluidly sealing an upper outer lip of said container under said lid.

25. The method of claim 22 further comprising:
securing said container to said user's body with a belt;
inserting the user's hand into said container through said diaphragm; and
removing said the live bait from said container with said user's hand.

26. The method of claim 25 further comprising:
positioning a curved exterior portion of said container to said user's body.

27. The method of claim 22 further comprising:
aerating said first volume of said container with a hose extending from said aerator.
